(19) United States
(12) Patent Application Publication
(10) Pub. No.: US 2021/0317020 A1
(43) Pub. Date: Oct. 14, 2021

(54) FILTER ELEMENTS FOR BIOLOGICAL FILTRATION ARRANGEMENTS

(71) Applicant: Mark Barrett, Bedfordshire (GB)

(72) Inventor: Mark Barrett, Bedfordshire (GB)

(21) Appl. No.: 14/128,320

(22) PCT Filed: Jun. 21, 2012
(86) PCT No.: PCT/GB2012/051447

§ 371 Date: Apr. 29, 2015

(30) Foreign Application Priority Data
Jun. 22, 2011 (GB) 1110594.7
Jul. 28, 2011 (GB) 1112982.2
Aug. 15, 2011 (GB) 1113976.3

(51) Int. Cl. C02F 3/10; B01J 19/30

(52) U.S. Cl. CPC C02F 3/109; B01J 19/30; B01J 2219/30223; C02F 2203/006; B01J 2219/30466; B01J 2219/312; B01J 2219/3183; B01J 2219/30296

(57) ABSTRACT

A filter element (1) comprising a central tubular body/core (2) and a plurality of radially outwardly directed fins (3) forming the main structure of the element, the radially outwardly directed fins (3) projecting outwardly from said central tubular body/core (2) and whose radial length increases stepwise from each end of the central body or core to a maximum length located centrally of the length of the body or core (2), thereby effectively providing a generally double back-to-back conical appearance, a stiffening ring (8) arranged to encircle with a gap therebetween the body/core (2) at a mid-region thereof and whose plane is perpendicular to the axis of the body or core (2), the central tubular body/core (2) including one or more radially inwardly directed ribs (12).

This invention relates to filter elements for use with apparatus for and/or methods of facilitating biological filtration of water containing biological waste materials.

It is well known to treat i.e., filter, water containing biological materials such as arises in relation to the management and disposal of waste biological materials arising from human activities, human food materials, animal food materials and general waste such as that commonly known as sewage material

In relation to at least the initial stages of such treatment it is known to retain the material to be treated in settling containers/tanks within which the sewage material undergoes at least the initial stages of the breakdown of the biological material content by bacterial action.

In practice, the bacteria involved require surfaces within the container/tank upon which to settle in order to be able to perform the required bacteriological filtering action. Such surfaces include the walls of the container/tank together with any other additional surfaces available within the container/tank. Conventionally such additional surfaces are provided by introducing into the container/tank a quantity of individual multi-surfaced elements commonly termed filter elements which combine or nest together, one upon the other, to form a bed of the elements within the container/tank. The bacteria ‘rest’ upon the surfaces of the filter elements and whilst so ‘resting’ upon the surfaces the bacteria biologically react with the waste material entrained within the water introduced into the container/tank in such manner as to remove the waste material from the water.

It will thus be appreciated that with the provision of such filter elements, the total surface area presented to the bacteria is many times greater than the actual surface area of the walls of any container/tank of the installation whereby the filtering capability of the installation is correspondingly increased.

In view of the purpose and function of the filtering installation and its filter elements, the contaminated water containing waste/sewage materials is conventionally continuously fed into the container/tank. This contaminated inlet water is intended to pass through the container/tank to a cleaned water outlet so located that water passing from the inlet to the outlet has to pass through the bed of filter elements.

In practice, the bacteria ‘feed’ upon the waste material entrained in the flow of water thereby extracting the material from the water flow and in so doing multiply progressively to provide an increasing density of active bacteria for removing the waste material and thus increasing filtering capability in the installation.

It is an object of the invention to provide an improved filter element construction providing an enhanced surface area available to bacteria.

It is also an object of the invention to provide an improved filter element construction that when in use it is capable of being randomly disposed within a filtering container/tank of a filtration plant.

According to an aspect of the invention there is provided a filter element comprising a central tubular body/core and a plurality of radially outwardly directed fins forming the main structure of the element, the radially outwardly directed fins projecting outwardly from said central tubular body/core and whose radial length increases stepwise from each end of the central body or core to a maximum length located centrally of the length of the body or core, thereby effectively providing a generally double back-to-back conical appearance, a stiffening ring arranged to encircle with a gap therebetween the body/core at a mid-region thereof and whose plane is perpendicular to the axis of the body or core, the central tubular body/core including one or more radially inwardly directed ribs.

Owing to this aspect, additional surfaces can be provided in a filter element upon which bacteria can grow. The actual physical volume that the element occupies is not significantly altered by the inwardly directed additional surfaces, so that there is still sufficient void space within the confines of the element for efficient water flow through it, without there being any significant obstruction to the flow of water.

Advantageously, additional surfaces may be provided about the body or core at appropriate locations. Such additional surfaces may be provided by fins projecting from the stiffening ring or the body/core.

In relation to the provision of the one or more ribs, the overall surface area of a filter element is increased by the projections extending lengthways of the inner surface of the body or core of the filter element. The outer surface of the central core may also be provided with corresponding channel portions.

Conveniently, the radially outwardly directed fins of the main structure of the filter elements have a serrated edge formation that enables the filter elements effectively to lock together once they have settled under gravity following their introduction into a container/tank in such manner as to provide an integrated aerobic filter bed.

The filter elements are advantageously made from a plastics material. The filter element may comprise a moulded plastics element.

In a particular embodiment, the edge of the stiffening ring is provided with cut-outs that serve to increase the effective length of this outer edge and assist in the locking together with other filter elements in the filter bed.

In a further preferred construction, a secondary smaller diameter ring co-axial with the axis of the body or core and co-planar with the stiffening ring interconnects the fins of the main structure in such manner as to further stiffen the fins against distortion.

In order that the present invention can be clearly and completely disclosed, reference will now be made, by way of example only, to the accompanying drawings, in which:—

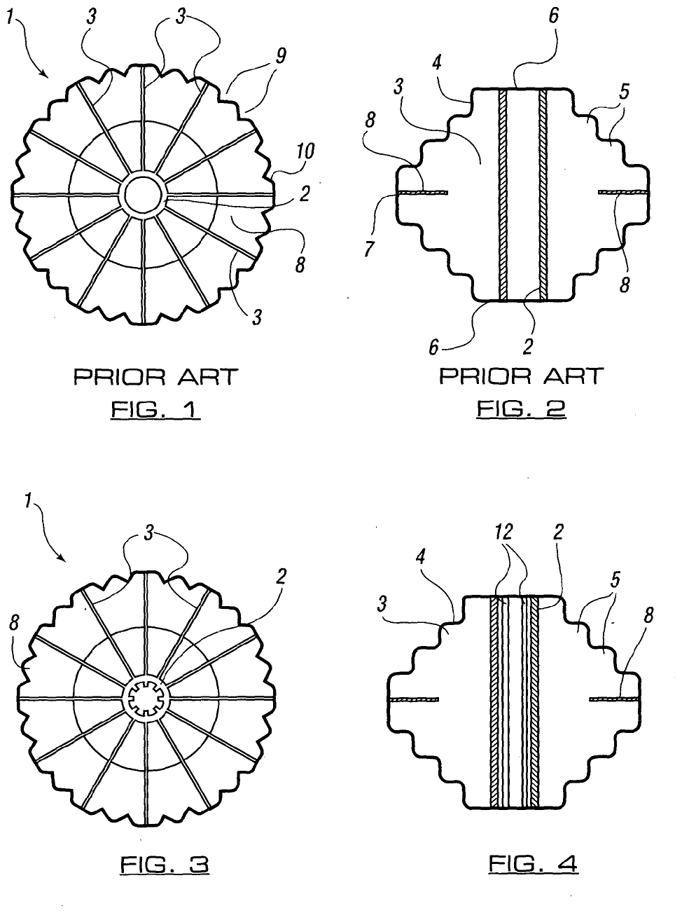

FIG. 1 is a plan view of embodiment of a known filter element,

FIG. 2 is a vertical section of the element illustrated in FIG. 1

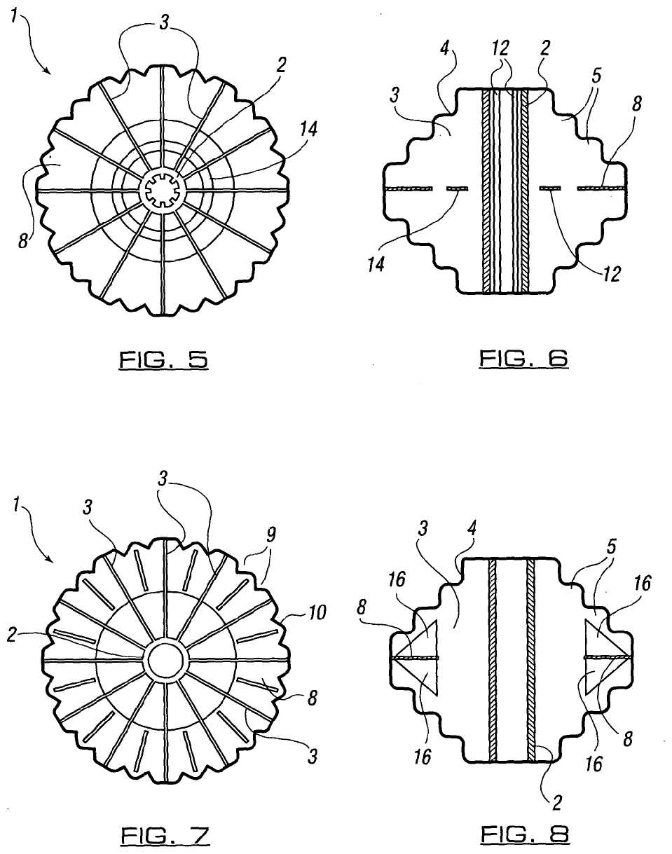

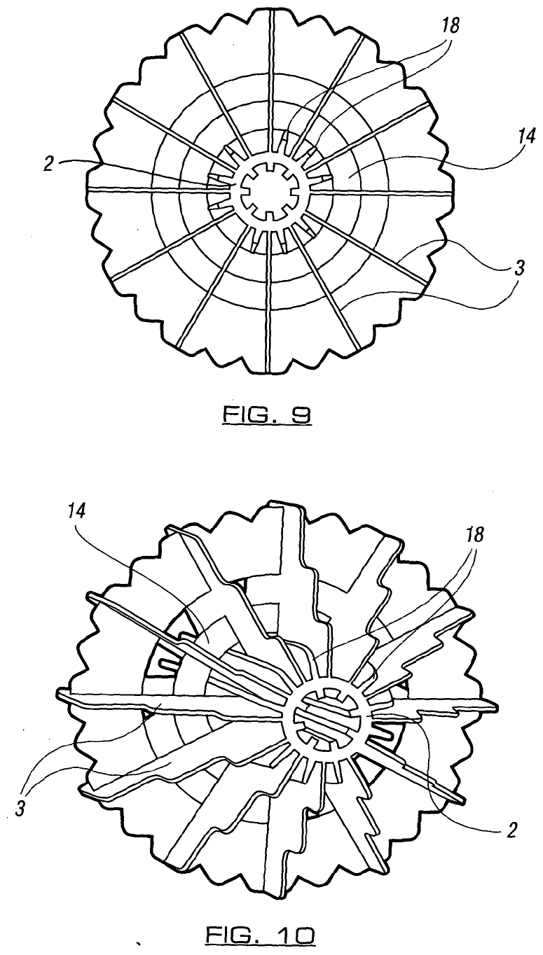

FIG. 3 is a plan view of an embodiment of a filter element incorporating the concepts of the present invention;

FIG. 4 is a vertical section of the element of FIG. 3,

FIG. 5 is a plan view of another embodiment of a filter element incorporating the concepts of the present invention;

FIG. 6 is a vertical section of the element of FIG. 5,

FIG. 7 is a plan view of a further embodiment of a filter element incorporating the concepts of the present invention; and

FIG. 8 is a vertical section of the element of FIG. 7,

FIG. 9 is a plan view of a further embodiment of a filter element incorporating the concepts of the present invention; and

FIG. 10 is a perspective view of the element of FIG. 9.

Referring to a known filter element 1 shown in FIGS. 1 and 2, the filter element 1 includes a central cylindrical body or core 2 from which extends a plurality of equi-angularly spaced radially directed main fins 3.

The outer free edges 4 of each fin 3 have a stepped profile as indicated in FIG. 2. Thus the free edge 4 of each main fin 3 is stepped outwards in two series (upper and lower) of a number of regular steps 5 from a minimum distance near each end 6 of the core 2 to a maximum distance located at a position 7 midway of the length of the core 2. The main fins 3 in the region of their maximum extensions from the core 2 are stiffened by an annular stiffening ring 8 that is integrally formed with the fins 3. As will be noted there is series of cut-outs 9 around the outer periphery 10 of the stiffening ring 8.

Referring to FIGS. 3 and 4 and with a view to increasing the overall surface area of the element 1 upon which bacteria can settle, the cylindrical body or core 2 is provided with projections in the form of a plurality of ribs 12 extending along the internal surface of the core 2. Although the ribs 12 are shown with a generally square cross-section, other cross-sectional shapes are possible, such as triangular for instance.

In the embodiment shown, the ribs 12 extend the whole length of the tubular core 2, although any suitable pattern would be possible, for example, a spiral formation of the ribs 12 which would extend the effective length of the ribs. Another possibility for increasing the effective length of the ribs 12 would be to have them in the form of broken lines, where the ribs are discontinuous.

In a modified embodiment shown in FIGS. 5 and 6, the filter element 1 incorporates a smaller diameter secondary stiffening ring 14 located between the body or core 2 and the inner periphery of the stiffening ring 8.

In a further embodiment shown in FIGS. 7 and 8, the stiffening ring 8 comprises small fins 16 extending substantially perpendicularly upwardly and downwardly therefrom. The maximum upward or downward extent of the small fins 16 can be from around 1 mm to around 15 mm, depending on the overall size of the filter element 1. In addition, the small fins 16 do not have to be positioned between each main fin 3, but may be located in any desired configuration or pattern, for example, between alternate spaces between the main fins 3. One advantage of the fins 16 is that they are relatively small to ensure that he element still has sufficient void space within its outer profile to allow water to flow through the element efficiently. The fins 16 may be of any desired shape, such as substantially triangular, as shown, or substantially rectangular, for instance.

Referring to the embodiment shown in FIGS. 9 and 10, the body or core 2 is provided with projections in the form of a plurality of elongate fins 18 extending along the external surface of the body or core 2. Of course, the embodiment of FIGS. 9 and 10 does not necessarily have to be provided with secondary stiffening ring 14 and could also comprise the small fins 16 as shown in FIGS. 7 and 8. As with the small fins 16 shown in FIGS. 7 and 8, the elongate fins 18 do not have to be positioned between each main fin 3, but may be located in any desired configuration or pattern. Again, one advantage of the elongate fins 18 is that they are relatively small to ensure that the element still has sufficient void space within its outer profile to allow water to flow through the element efficiently.

It will be apparent that the formation of the filter element 1 illustrated in FIGS. 3 to 10 provides a multi-surface arrangement providing a considerably increased surface area upon which bacteria can settle. Provision of the increased surface area allows for, effectively, an increased contact time of the water and the bacteria on the element and thus a more efficient cleaning of the water.

The above described filter elements can preferably be formed from a polypropylene, which is advantageously from a recycled source, or other plastics material appropriate to the operation conditions of an aerobic treatment plant. It will be appreciated that the filter elements can be of many different forms other than that illustrated in FIGS. 3 to 10.

The surfaces of the various components of the elements can be such as to present roughened surfaces which effectively provides a considerable increase in the surface area available to the settlement of the bacteria as compared with a similar element having smooth surfaces.

Water containing material that it is to be removed by the filter elements is arranged to flow into the container/tank in such manner that in flowing from the water inlet into the container/tank towards a water outlet, the water is caused to flow through a bed of the filter elements. In practice the inlet water is conventionally delivered by way of pipes, ducting or the like.

The inlet water is to flow through the bed of filter elements and is effectively divided into a plurality of much reduced velocity flows by reason of the form of the filter elements producing channeling effects, so that the contaminated water passes relative to the various surfaces of the elements at much reduced rates of flow thereby increasing contact time between the material contained in the water and the many surfaces of the elements forming the filtering bed.

In practice, it has been found that any combination of the ribs 12, the small fins 16 and the elongate fins 18 increases the overall number of the water flow channels available to the water during its flow through the main container/tank. The ribs 12, the small fins 16 and the elongate fins 18 assist in ensuring that there are adequate mini-flows of the water whereby the entrained biological materials are able freely to pass through an agglomeration of the filter elements, and also not to unnecessarily lead to an increase in any clogging of the elements.

Whilst the above discussed embodiments have involved circular cylindrical cores, in practice any other shaped core is possible.

As will be appreciated the filter elements will, during sustained use, tend to become blocked/clogged whereby the throughput efficiency of the filtering system is reduced. In addition there is the possibility that the activity of the bacteria may diminish. As a result of these factors it becomes, from time-to-time, necessary to replace the filter elements with new filter elements or reclaimed and cleaned filter elements.

Historically the removal of the filter elements from their container/tank has frequently been a tedious time-consuming activity and at times somewhat practically difficult in view of the siting of the container/tank frequently underground and only accessible through a manhole.

With a view to removing such difficulties the filter elements as above discussed can be introduced into one of more secondary containers which allow the flow of water therethrough and whereby the removal of the filter elements involves removing one or more such secondary containers containing the filter elements required to be replaced from the container/tank.

In practice, the handling of their secondary enclosures and their filter element content can be facilitated by providing each secondary enclosure with a handling rope or the like whose free end is retained in the vicinity of any manhole or other access region to the interior of the container/tank.

1. A filter element comp sing a central tubular body/core and a plurality of radially outwardly directed fins forming the main structure of the element, the radially outwardly directed fins projecting outwardly from said central tubular body/core and whose radial length increases stepwise from each end of the central body or core to a maximum length located centrally of the length of the body or core, thereby effectively providing a generally double back-to-back conical appearance, a stiffening ring arranged to encircle with a gap therebetween the body/core at a mid-region thereof and whose plane is perpendicular to the axis of the body or core, the central tubular body/core including one or more radially inwardly directed ribs.

2. A filter element according to claim 1, and further comprising additional surfaces provided about the body/core.

3. A filter element according to claim 2, wherein said additional surfaces are provided by elongate fins projecting from the external surface of the body/core.

4. A filter element according to claim 1, and further comprising fins projecting from the stiffening ring.

5. A filter element according to claim 4, wherein the fins projecting from the stiffening ring extend substantially perpendicularly therefrom.

6. A filter element according to claim 4, wherein the maximum extent of the fins is between around 1 mm to around 15 mm.

7. A filter element according to claim 1, wherein the one or more ribs extend lengthways of the inner surface of the tubular body/core.

8. A filter element according to claim 1, wherein said one or more ribs are discontinuous along their length.

9. A filter element according to claim 2, and further comprising, on the outer surface of the central tubular body/core, channel portions corresponding to the one or more inwardly directed ribs.

10. A filter element according to claim 1, wherein the radially outwardly directed fins have a serrated edge formation.

11. A filter element according to claim 1, wherein the stiffening ring is provided with cut-outs that serve to increase the effective length of its radially outer edge.

12. A filter element according to claim 1, and further comprising a secondary stiffening ring of smaller diameter than the first mentioned stiffening ring, said secondary stiffening ring being co-axial with the axis of the body or core and co-planar with the first mentioned stiffening ring.

13. A filter element according to claim 1, wherein the surfaces of the element can be such as to present roughened surfaces.

14. A filter element according to claim 5, wherein the maximum extent of the fins is between around 1 mm to around 15 mm.
